(19) United States
(12) Patent Application Publication
(10) Pub. No.: US 2025/0358392 A1
(43) Pub. Date: Nov. 20, 2025

(54) BEAM TRANSMISSION MODULE AND A PROJECTION DEVICE

(71) Applicant: Coretronic Corporation, Hsin-Chu (TW)

(72) Inventors: Ming-Chen LIU, Hsin-Chu (TW); Wei-Hao CHEN, Hsin-Chu (TW)

(21) Appl. No.: 19/182,649

(22) Filed: Apr. 18, 2025

(30) Foreign Application Priority Data
May 15, 2024 (CN) 2024105982791

(51) Int. Cl. H04N 9/31

(52) U.S. Cl. CPC H04N 9/3152; H04N 9/3144; H04N 9/3197

(57) ABSTRACT

A beam transmission module and a projection device with this beam transmission module. The beam transmission module includes a bracket, an actuator assembly, an optical assembly, and a bracket cover. The actuator assembly is configured on the bracket and is located on the transmission path of the image beam. The optical assembly is configured on the bracket and is located on the transmission path of the illumination beam. The bracket cover carries the optical assembly and is connected to the bracket. The beam transmission module and the projection device of this invention can simplify the design complexity and assembly cost of the projection device.

### CROSS-REFERENCES

This application claims the priority benefit of Chinese Patent Application Serial Number 2024105982791, filed on May 15, 2024, the full disclosure of which is incorporated herein by reference.

### TECHNICAL FIELD

The present disclosure relates to a beam transmission module and a projection device.

### DESCRIPTION OF RELATED ART

A projection device (such as a projector) is a display device used to produce images. The imaging principle of a projection device is to convert the illumination beam generated by the illumination system into an image beam through a light valve assembly, and then project the image beam onto a projection surface such as a screen or a wall through a projection lens. As projection devices are widely used in homes, each component of the projection device is designed to be smaller to be assembled in the limited configuration space of a miniaturized projection device, allowing the projection device to be placed close to the projection surface, similar to the usage habits of existing display devices. However, the assembly of multiple small-sized components is more difficult and interferes with each other, increasing the design complexity and assembly cost of the projection device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE INVENTION

The present invention provides a beam transmission module and a projection device that can simplify the design complexity and assembly cost of the projection device.

To achieve the above one or part or all of the objectives or other objectives, an embodiment of the present invention provides a beam transmission module, comprising a bracket, an actuator assembly, an optical assembly, and a bracket cover. The actuator assembly is configured on the bracket and located on the transmission path of the image beam. The optical assembly is configured on the bracket and located on the transmission path of the illumination beam. The bracket cover carries the optical assembly and is connected to the bracket.

To achieve the above one or part or all of the objectives or other objectives, an embodiment of the present invention provides a projection device, comprising an illumination system, a light valve assembly, a beam transmission module, and a projection lens. The illumination system is configured to provide an illumination beam. The light valve assembly is configured to convert the illumination beam into an image beam. The projection lens projects the image beam from the actuator assembly out of the projection device. The beam transmission module comprises a bracket, an actuator assembly, an optical assembly, and a bracket cover. The actuator assembly is configured on the bracket and located on the transmission path of the image beam. The optical assembly is configured on the bracket and located on the transmission path of the illumination beam. The bracket cover carries the optical assembly and is connected to the bracket.

Based on the above, the embodiments of the present invention have at least one of the following advantages or effects. In the beam transmission module of the present invention, multiple components (such as the actuator assembly and the optical assembly) share a single bracket and are modularized. In this way, during the assembly process of the projection device, installing the beam transmission module in the projection device is equivalent to completing the configuration and assembly of multiple components, thus reducing the design complexity and assembly cost of the projection device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF DRAWINGS

FIG. 1 is a block diagram of a projection device according to an embodiment of the present invention.

FIG. 2 is a perspective diagram of the projection device as shown in FIG. 1.

FIG. 3 is an exploded view of the projection device as show in FIG. 2.

FIG. 4 is a perspective diagram of a beam transmission module according to an embodiment of the present invention.

FIG. 5 is another perspective diagram of the beam transmission module according to an embodiment of the present invention.

FIG. 6 is an exploded view of the beam transmission module according to an embodiment of the present invention.

FIG. 7 is a perspective diagram of a bracket cover according to an embodiment of the present invention.

FIG. 8 is a perspective diagram of a light engine housing according to an embodiment of the present invention.

FIG. 9 is another perspective diagram of the light engine housing according to an embodiment of the present invention.

FIG. 10 is yet another perspective diagram of the light engine housing according to an embodiment of the present invention.

### DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

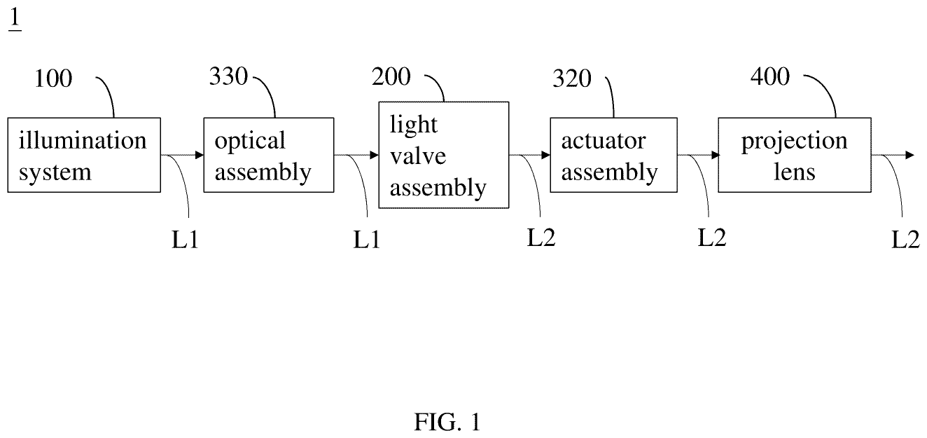

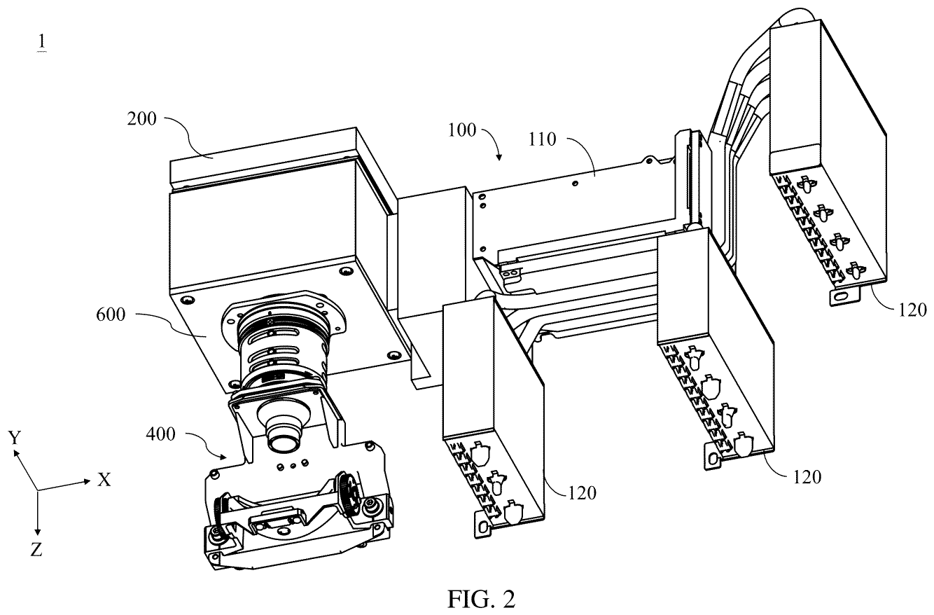

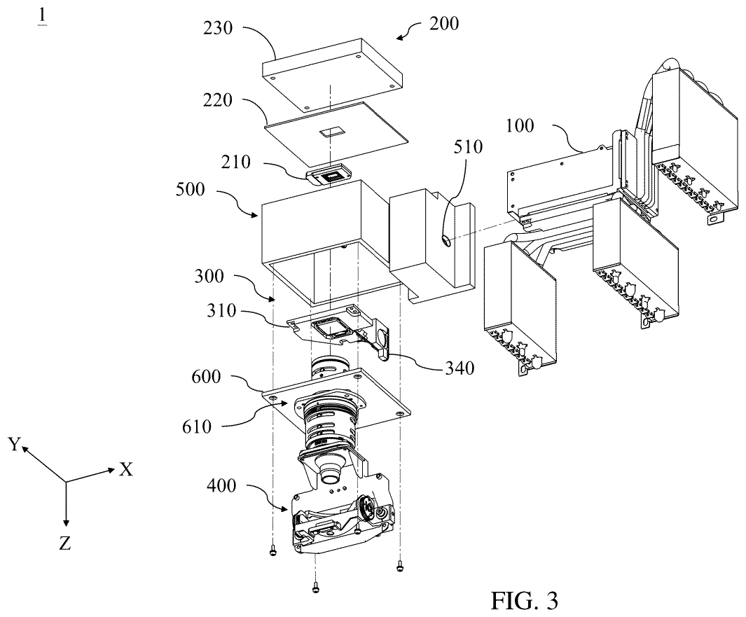

FIG. 1 is a block diagram of a projection device according to an embodiment of the present invention. FIG. 2 is a perspective diagram of the projection device in FIG. 1. FIG. 3 is an exploded view of the projection device. Please refer to FIG. 1, FIG. 2, and FIG. 3. The projection device 1 of this embodiment comprises an illumination system 100, a light valve assembly 200, a beam transmission module 300, and a projection lens 400. The first direction X, the second direction Y, and the third direction Z are illustrated in the figures to clearly understand the perspective of each figure. The first direction X and the second direction Y are perpendicular to each other in the figures. The third direction Z is perpendicular to both the first direction X and the second direction Y.

The illumination system 100 is disposed on one side of the beam transmission module 300 along the first direction X, and the illumination system 100 is configured to provide the illumination beam L1 to the beam transmission module 300. The illumination system 100 comprises an illumination system body 110 and a plurality of heat dissipating assemblies 120. The plurality of heat dissipating assemblies 120 are connected to the illumination system body 110 via pipes (such as heat pipes). The plurality of heat dissipating assemblies 120 are disposed along the third direction Z. When the projection device 1 is placed near the projection surface, the distance between the projection lens 400 and the projection surface is almost unaffected by the multiple heat dissipating assemblies 120, and the projection device 1 of this embodiment can be disposed close to the projection surface. FIG. 2 and FIG. 3 schematically illustrate the illumination system body 110 and multiple heat dissipating assemblies 120. The illumination system body 110 can comprise at least one light-emitting element, such as a light-emitting diode, a laser diode, a combination of the above, or other types of light sources. In one embodiment, the illumination system body 110 can also comprise a wavelength conversion element (such as a phosphor wheel), a light homogenizing element (such as an integrating rod), a filter element (such as a filter wheel), and multiple light combining and splitting elements. The heat dissipating assembly 120 can comprise cooling fins and heat pipes.

The beam transmission module 300 comprises a bracket 310, an actuator assembly 320, an optical assembly 330, and a bracket cover 340. The optical assembly 330 is configured to receive the illumination beam L1 from the illumination system 100 and transmit the illumination beam L1 to the light valve assembly 200. The optical assembly 330 is configured on the bracket 310 and located on the transmission path of the illumination beam L1, and the optical assembly 330 is not located on the transmission path of the image beam L2.

The light valve assembly 200 is configured to convert the illumination beam L1 into the image beam L2, and the light valve assembly 200 transmits the image beam L2 to the actuator assembly 320. The actuator assembly 320 is configured on the bracket 310 and located on the transmission path of the image beam L2. The actuator assembly 320 is configured to transmit the image beam L2 to the projection lens 400. The actuator assembly 320 is located on the transmission path of the image beam L2 and not on the transmission path of the illumination beam L1.

The bracket cover 340 is configured at the bottom of the bracket 310. The bracket cover 340 carries the optical assembly 330, and the bracket cover 340 is connected and covered with the bracket 310. The bracket 310 carries both the actuator assembly 320 and the optical assembly 330.

The projection lens 400 is disposed on one side of the beam transmission module 300 along the third direction Z. The projection lens 400 projects the image beam L2 from the actuator assembly 320 out of the projection device 1. The projection lens 400, for example, comprises one or more combinations of optical lenses with diopter, such as double concave lenses, double convex lenses, concave convex lenses, convex concave lenses, plano-convex lenses, and plano-concave lenses, among other combinations of non-planar lenses. In other embodiments, the projection lens 400 can also comprise planar optical lenses to reflectively project the image beam L2 onto the projection target. The present invention does not limit the type and form of the projection lens 400. In one embodiment, the projection lens 400 is an ultra-short-throw projection lens.

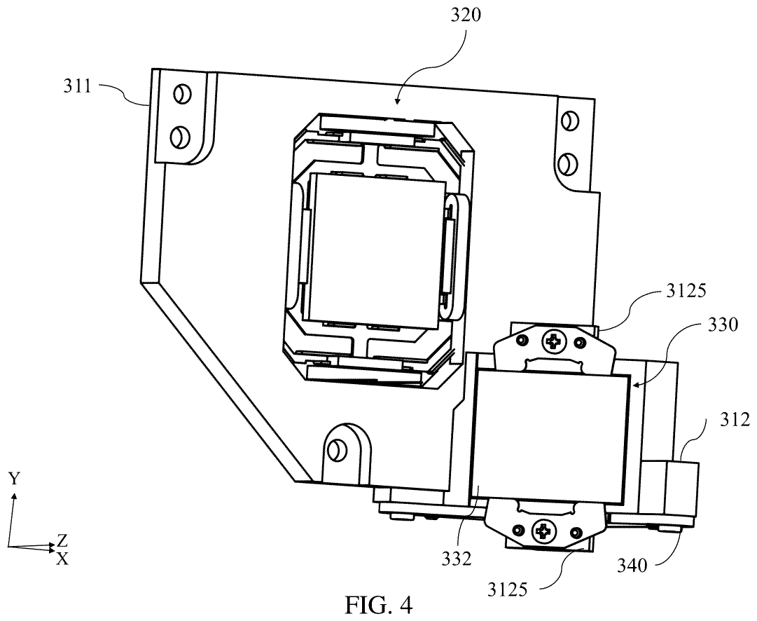

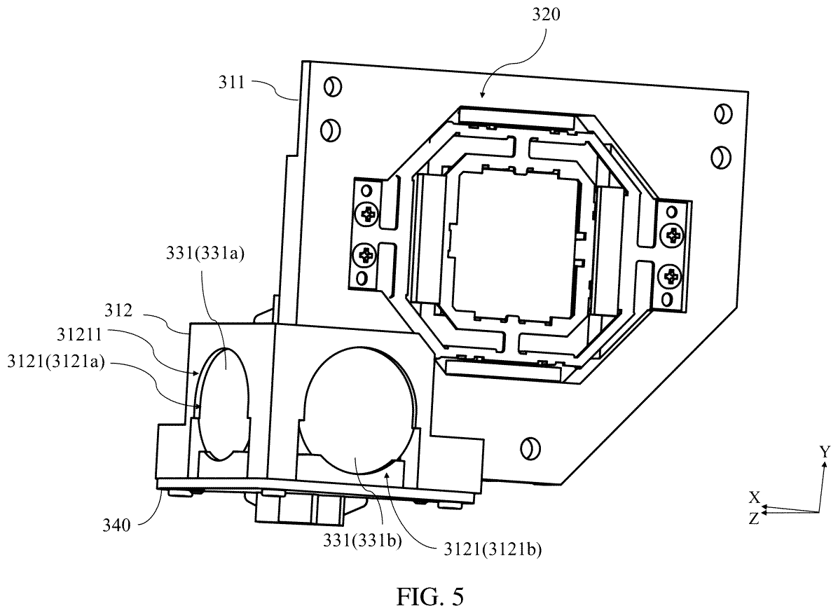

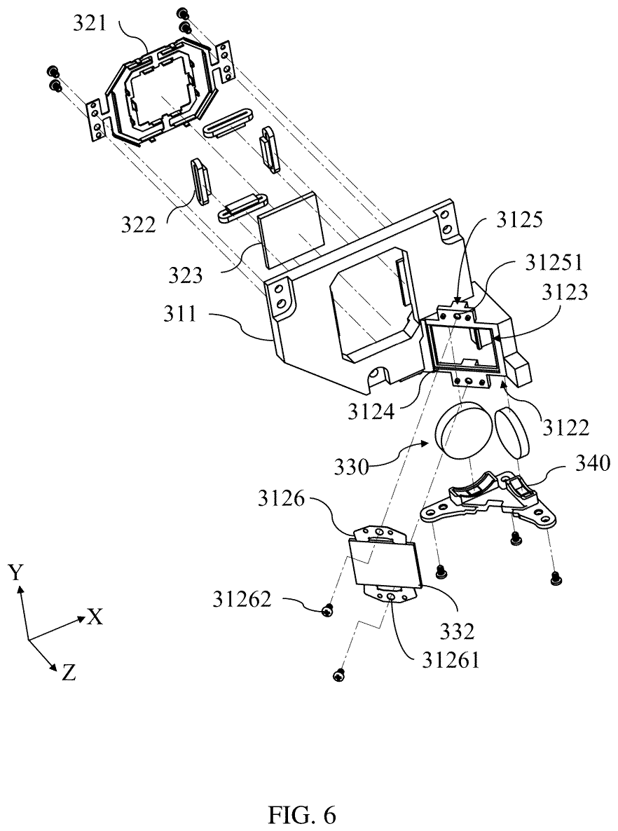

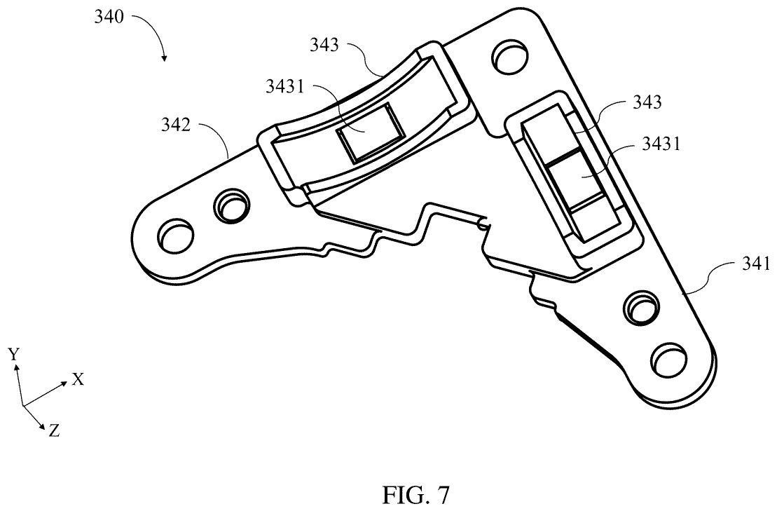

FIG. 4 is a perspective diagram of a beam transmission module according to an embodiment of the present invention. FIG. 5 is another perspective diagram of the beam transmission module according to an embodiment of the present invention. FIG. 6 is an exploded view of the beam transmission module according to an embodiment of the present invention. FIG. 7 is a perspective diagram of a bracket cover according to an embodiment of the present invention. Please refer to FIG. 4, FIG. 5, FIG. 6 and FIG. 7. The bracket 310 comprises a first frame part 311 and a second frame part 312 connected to each other. The actuator assembly 320 is configured on the first frame part 311. The optical assembly 330 is configured on the second frame part 312. The optical assembly 330 comprises at least one of the lenses 331 and the reflecting element 332. The number of lenses 331 and reflecting elements 332 can be adjusted according to the optical path design. The bracket cover 340 is connected and covered with the second frame part 312. The second frame part 312 extends from the first frame part 311 in a direction away from the first frame part 311. In this embodiment, as shown in FIG. 3, the second frame part 312 extends in the direction close to the projection lens 400. The shape of the first frame part 311 is, for example, a regular or irregular plate shape, and the shape of the second frame part 312 is, for example, a triangular prism.

The second frame part 312 of the bracket 310 has a plurality of openings 3121. The orientations of the multiple openings 3121 are different from each other. The orientations of the multiple openings 3121 are perpendicular to each other. The second frame part 312 has a plurality of grooves 31211. The multiple grooves 31211 are disposed on the side of the second frame part 312 away from the bracket cover 340 corresponding to the multiple openings 3121. The optical assembly 330 comprises a plurality of lenses 331, and the multiple lenses 331 are placed in the multiple openings 3121. Part of the edges of the lenses 331 rest in the grooves 31211. The lenses 331 are fixed in the openings 3121 by the grooves 31211. Each opening 3121 is used to accommodate and fix a lens 331. As shown in FIG. 5, the orientation of the opening 3121a is different from the orientation of the opening 3121b. The orientation of the opening 3121a is perpendicular to the orientation of the opening 3121b. The orientation of the opening 3121a is parallel to the main optical axis of the illumination beam L1 from the illumination system 100. The orientation of the opening 3121b is parallel to the optical axis of the image beam L2 received by the projection lens 400.

The bracket cover 340 has a first side 341 and a second side 342. The first side 341 and the second side 342 are perpendicular to each other. The bracket cover 340 is provided with carrying grooves 343 along the first side 341 and the second side 342. The carrying grooves 343 carry the lenses 331. The second frame part 312 has a bottom opening 3122. The bottom opening 3122 corresponds to the shape of the second frame part 312 and is triangular. The bracket cover 340 covers the bottom opening 3122 and is combined with the bottom opening 3122. The bracket cover 340, which is covered with the bottom opening 3122, cooperates with the grooves 31211 of the openings 3121 to fix the multiple lenses 331 in the multiple openings 3121 of the second frame part 312. The lenses 331 are located between the openings 3121 of the second frame part 312 and the carrying grooves 343 of the bracket cover 340. The carrying grooves 343 are provided with elastic members 3431. The elastic members 3431 support against the lenses 331 located in the carrying grooves 343. In this embodiment, the elastic members 3431 are, for example, rubber blocks. In this way, when the bracket cover 340 is covered with the bottom opening 3122, the elastic members 3431 of the carrying grooves 343 provide force to the lenses 331 in a direction toward the openings 3121, fixing the lenses 331 between the openings 3121 of the second frame part 312 and the carrying grooves 343 of the bracket cover 340. The bracket cover 340 is triangular for corresponding to the bottom opening 3122.

The optical assembly 330 comprises a reflecting element 332. The reflecting element 332 is configured to reflect and transmit the illumination beam L1 from one lens 331 to another lens 331 so that the illumination beam L1 can be transmitted to the light valve assembly 200 through the optical assembly 330. In one embodiment, the reflecting element 332 is a mirror. As shown in FIG. 5, the reflecting element 332 is configured to reflect and transmit the illumination beam L1 from lens 331a to lens 331b. As shown in FIG. 6, the second frame part 312 of the bracket 310 has an opening 3123 and a step portion 3124 formed on the periphery of the opening 3123 of the second frame part 312. The step portion 3124 is configured to carry the reflecting element 332 of the optical assembly 330. The second frame part 312 of the bracket 310 has a plurality of fixing portions 3125 (shown in FIG. 4). The multiple fixing portions 3125 are individually located on one side of the opening 3123. The second frame part 312 of the bracket 310 comprises a plurality of fixing members 3126. The multiple fixing portions 3125 are corresponding to the multiple fixing members 3126. The multiple fixing portions 3125 may have screw holes 31251, the multiple fixing members 3126 may have through holes 31261, the multiple fixing members 3126 and the multiple fixing portions 3125 can be locked by screws 31262, and the multiple fixing members 3126 support against the reflecting element 332. In this way, the reflecting element 332 of the optical assembly 330 is fixed in the opening 3123 of the second frame part 312 by the multiple fixing members 3126.

In this embodiment, the second frame part 312 of the bracket 310 is integrally formed with the first frame part 311. In this way, the optical assembly 330 and the actuator assembly 320 are not restricted by separate assembly and do not interfere with each other, and can be modularized by the bracket 310, improving the difficulty of assembling multiple components and reducing the design complexity and assembly cost of the projection device. At the same time, multiple components can be closely arranged in a single bracket 310, thereby reducing the overall size of the projection device and achieving the purpose of miniaturization of the projection device.

The actuator assembly 320 includes a support member 321, a driving element 322, and an optical component 323. The support member 321 and the driving element 322 are fixed on the first frame part 311 of the bracket 310. The optical component 323 is fixed on the support member 321 and located in the first frame part 311. The driving element 322 comprises a coil and a (electro) magnet. The optical component 323 is, for example, glass. In one embodiment, the magnet of the driving element 322 and the optical component 323 are disposed on the support member 321, and the coil of the driving element 322 is disposed on the first frame part 311. The optical component 323 is located on the transmission path of the image beam L2. In another embodiment, the magnet of the driving element 322 can be disposed on the first frame part 311, and the coil of the driving element 322 can be disposed on the support member 321. In this way, the support member 321 can swing relative to the first frame part 311 based on the driving of the driving element 322, thereby driving the optical component 323 to swing. In this embodiment, the support member 321 is disposed on one side of the first frame part 311 toward the light valve assembly 200. In other embodiments, the support member 321 can be disposed on one side of the first frame part 311 toward the projection lens 400.

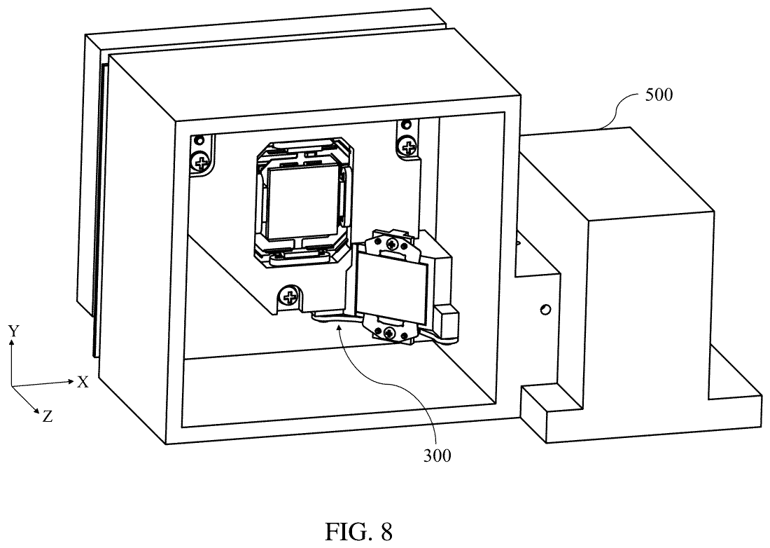

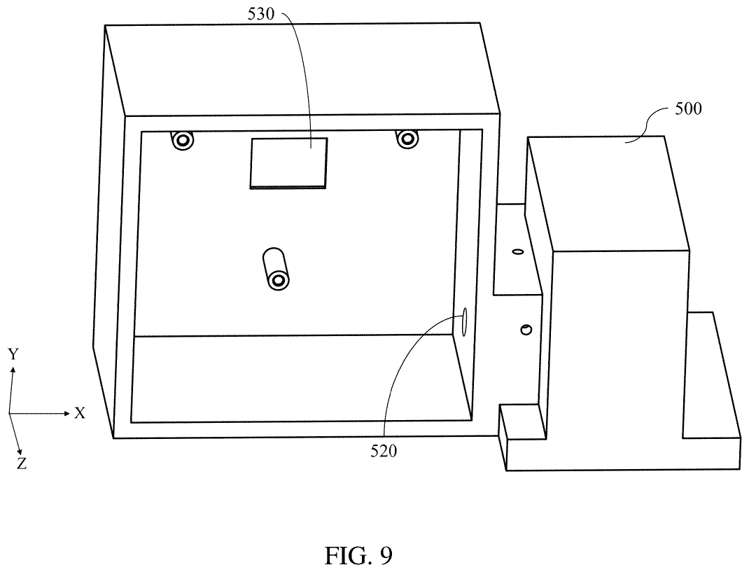

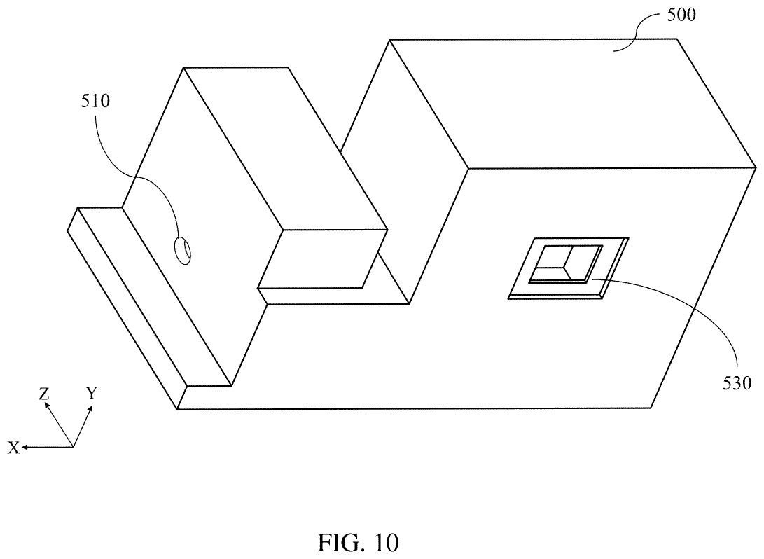

FIG. 8 is a perspective diagram of a light engine housing according to an embodiment of the present invention. FIG. 9 is another perspective diagram of the light engine housing according to an embodiment of the present invention. FIG. 10 is yet another perspective diagram of the light engine housing according to an embodiment of the present invention. The projection device 1 comprises a light engine housing 500, and the beam transmission module 300 is disposed in the light engine housing 500. The light engine housing 500 has an inlet 510 and an outlet 520. The inlet 510 is disposed on one side of the light engine housing 500 toward the illumination system 100, and the outlet 520 is disposed inside the light engine housing 500 and toward the beam transmission module 300. The inlet 510 and the outlet 520 are connected. The inlet 510 receives the illumination beam L1 from the illumination system 100. The outlet 520 transmits the illumination beam L1 to the lenses 331 of the optical assembly 330 of the beam transmission module 300, that is to say, the illumination beam passes through the inlet 510 and the outlet 520 sequentially. Please refer to FIG. 5, FIG. 8, and FIG. 9 simultaneously. In this embodiment, the outlet 520 is oriented toward the lens 331a. After the illumination beam L1 passes through the outlet 520, it is transmitted to the lens 331a.

Please refer to FIG. 2 and FIG. 3. The projection device 1 further comprises a light engine front cover 600. The light engine front cover 600 has a lens opening 610. The light engine front cover 600 is covered with the light engine housing 500. One end of the projection lens 400 is inserted into the lens opening 610. The beam transmission module 300 is located between the projection lens 400 and the light engine housing 500. In one embodiment, the bracket 310 of the beam transmission module 300 can be fixedly or removably attached to the light engine front cover 600 or the projection lens 400.

Please refer to FIG. 9 and FIG. 10. The light engine housing 500 comprises an opening 530, which is located on the side of the light engine housing 500 toward the light valve assembly 200. The light valve assembly 200 is configured on the side of the light engine housing 500 away from the beam transmission module 300. The beam transmission module 300 is located between the projection lens 400 and the light valve assembly 200. The light valve assembly 200 comprises an light valve element 210, a circuit board 220, and a heat dissipation module 230. At least part of the light valve assembly 200 is accommodated in the light engine housing 500. The light valve element 210 is located in the opening 530 of the light engine housing 500 and provided on the circuit board 220. The light valve element 210 is located between the actuator assembly 320 of the beam transmission module 300 and the circuit board 220. The effective imaging area of the light valve element 210 faces toward the actuator assembly 320 inside the light engine housing 500 through the opening 530. The heat dissipation module 230 is disposed on the side of the circuit board 220 away from the light engine housing 500. The light valve element 210 is configured to convert the illumination beam L1 from the beam transmission module 300 into the image beam L2. In this embodiment, the light valve element 210 can be a Digital Micromirror Device (DMD), a Liquid Crystal on Silicon panel (LCoS panel), and other reflective light modulators, transparent liquid crystal panels (Transparent Liquid Crystal Panel), Electro-Optical Modulator, Magneto-Optic modulator, Acousto-Optic Modulator (AOM), and other transmissive light modulators, and the present invention is not limited thereto.

In this embodiment, the projection device 1 forms a sealed space through the illumination system 100, the light valve assembly 200, the beam transmission module 300, the projection lens 400, the light engine housing 500, and the light engine front cover 600, effectively preventing the internal components of the projection device 1 from being unexpectedly contaminated.

In summary, the embodiments of the present invention have at least one of the following advantages or effects. In the beam transmission module of the present invention, multiple components (such as the optical assembly and the actuator assembly) respectively located on the optical path of the illumination beam and the image beam can share a single bracket and be integrated into the beam transmission module for modularization. In this way, the multiple components do not interfere with each other. Furthermore, during the assembly process of the projection device, installing the beam transmission module into the projection device is equivalent to completing the configuration and assembly of multiple components, thus reducing the design complexity and assembly cost of the projection device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A beam transmission module, comprising:
a bracket;
an actuator assembly configured on the bracket and located on a transmission path of an image beam;
an optical assembly configured on the bracket and located on a transmission path of an illumination beam; and
a bracket cover carrying the optical assembly and connected to the bracket.

2. The beam transmission module as claimed in claim 1, wherein the bracket comprises a first frame part and a second frame part connected to each other, the actuator assembly is configured on the first frame part, the optical assembly is configured on the second frame part, and the bracket cover is connected to the second frame part.

3. The beam transmission module as claimed in claim 2, wherein the second frame part extends from the first frame part in a direction away from the first frame part.

4. The beam transmission module as claimed in claim 2, wherein the second frame part of the bracket has a plurality of openings, the optical assembly comprises a plurality of lenses, and the plurality of lenses are placed in the plurality of openings.

5. The beam transmission module as claimed in claim 4, wherein the orientations of the plurality of openings are different from each other.

6. The beam transmission module as claimed in claim 4, wherein the orientations of the plurality of openings are perpendicular to each other.

7. The beam transmission module as claimed in claim 4, wherein the bracket cover has a first side and a second side, and the bracket cover is provided with carrying grooves along the first side and the second side, the carrying grooves carrying the lenses.

8. The beam transmission module as claimed in claim 7, wherein the first side and the second side are perpendicular to each other.

9. The beam transmission module as claimed in claim 7, wherein the second frame part has a bottom opening, the bracket cover is combined with the bottom opening, and the plurality of lenses are fixed in the plurality of openings.

10. The beam transmission module as claimed in claim 7, wherein the carrying grooves are provided with elastic members, and the elastic members support against the lenses.

11. The beam transmission module as claimed in claim 2, wherein the optical assembly includes a reflecting element, the second frame part of the bracket has an opening and a step portion formed at the periphery of the opening, and the step portion is configured to carry the reflecting element of the optical assembly.

12. The beam transmission module as claimed in claim 11, wherein the second frame part of the bracket comprises a plurality of fixing members, and the plurality of fixing members are locked onto the second frame part and support against the reflecting element.

13. The beam transmission module as claimed in claim 2, wherein the second frame part is integrally formed with the first frame part.

14. The beam transmission module as claimed in claim 2, wherein the actuator assembly comprises a support member, a driving element, and an optical component, the support member and the driving element are fixed on the first frame part of the bracket, and the optical component is fixed on the support member and located in the first frame part.

15. The beam transmission module as claimed in claim 1, wherein the optical assembly is not located on the transmission path of the image beam.

16. A projection device, comprising:
an illumination system for providing an illumination beam;
a light valve assembly for converting the illumination beam into an image beam;
a beam transmission module comprising a bracket, an actuator assembly, an optical assembly, and a bracket cover, wherein:
the actuator assembly is configured on the bracket and located on a transmission path of the image beam;
the optical assembly is configured on the bracket and located on a transmission path of the illumination beam; and
the bracket cover carries the optical assembly and is connected to the bracket; and
a projection lens for projecting the image beam from the actuator assembly out of the projection device.

17. The projection device as claimed in claim 16, wherein the projection device comprises a light engine housing, and the beam transmission module is disposed in the light engine housing.

18. The projection device as claimed in claim 17, wherein the projection device further comprises a light engine front cover, the light engine front cover has a lens opening, the light engine front cover is fitted with the light engine housing, the lens opening allows one end of the projection lens to pass through, and the bracket of the beam transmission module is fixed to the light engine front cover or the projection lens.

19. The projection device as claimed in claim 17, wherein the light valve assembly is configured on the side of the light engine housing away from the beam transmission module.

20. The projection device as claimed in claim 16, wherein the optical assembly is configured to transmit the illumination beam to the light valve assembly, and the actuator assembly is configured to transmit the image beam to the projection lens.
